(19) United States
(12) Patent Application Publication
(10) Pub. No.: US 2010/0128504 A1
(43) Pub. Date: May 27, 2010

(54) MULTI-CHANNEL SWITCHING-MODE POWER SUPPLY, AND IMAGE FORMING APPARATUS AND ELECTRONIC DEVICE HAVING THE MULTI-CHANNEL SWITCHING-MODE POWER SUPPLY

(75) Inventors: Seung-hak LEE, Hwaseong-si (KR); Chang-su Ma, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/620,712

(22) Filed: Nov. 18, 2009

(30) Foreign Application Priority Data
Nov. 25, 2008 (KR) 2008-117477

(51) Int. Cl. H02M 7/04

(52) U.S. Cl. 363/89

(57) ABSTRACT

A multi-channel switching-mode power supply (SMPS), an image forming apparatus and an electronic device having the multi-channel SMPS, the multi-channel SMPS including a first converter to rectify, switch, and transform AC power to generate a first DC power; a second converter to rectify, switch, and transform the AC power to generate a second DC power; a first power output unit to output the first DC power generated in the first converter; a second power output unit to output the second DC power generated in the second converter; and a second power feedback circuit unit to sense output of the first DC power from the first power output unit and immediately output a feedback signal which causes the second DC power to be generated, wherein the second converter generates the second DC power, and the second power output unit outputs the second DC power, in response to the feedback signal being output from the second power feedback circuit unit.

### CROSS-REFERENCE TO RELATED APPLICATIONS

This application claims the benefit under 35 U.S.C. §119(a) of Korean Patent Application No. 10-2008-0117477, filed on Nov. 25, 2008, in the Korean Intellectual Property Office, the disclosure of which is incorporated herein by reference in its entirety.

### BACKGROUND

1. Field of the Invention

The present general inventive concept relates to a switching-mode power supply (SMPS), and more particularly, to a multi-channel SMPS, an image forming apparatus and an electronic device having the multi-channel SMPS.

2. Description of the Related Art

Recently, lower power consumption of electronic products has become an essential issue in saving energy. In particular, power used when an electronic product is not actually in use, but power is still being supplied to the electronic product, has become a focus point in the attempt to conserve energy. Although the electronic device is considered to be in a power save mode when not in use and still drawing power, the electronic device is nevertheless considered to be wasting energy, and thus the need to minimize power consumption increases.

A multi-channel switching-mode power supply (SMPS) uses only a channel which supplies minimum power in a power save mode.

In more detail, when a 5V/24V multi-channel SMPS is used, the 5V channel is used as a power source of a main controller, and the 24V channel is turned-off so as not to supply power to the main controller to minimize power consumption in power save mode.

However, in this case, when power is supplied to an electronic product, the initialization of the main controller to which the 5V channel is applied is finished before the 24V channel is turned-on, and thus the time needed to enter the power save mode of the electronic product may be delayed.

Also, when the power supply is stopped before the 24V channel is turned-on, energy stored in the SMPS cannot be sufficiently discharged due to the load existing only on the 5V channel, and thus presents a safety hazard due to the remaining energy.

For example, if a user unplugs a power cord before the 24V channel is turned-on, and the user contacts the unplugged power cord when power supply is stopped, the user may receive an electric shock due to the remaining energy, which had not been discharged sufficiently.

Accordingly, a method of effectively controlling a multi-channel SMPS which uses a SMPS multi-channel method of low power consumption and decreasing a safety hazard is desired.

### SUMMARY

Example embodiments of the present general inventive concept provide a multi-channel switching-mode power supply (SMPS) which uses an SMPS multi-channel method of low power consumption and decreases a safety hazard.

The present general inventive concept also provides an image forming apparatus and an electronic device having the multi-channel SMPS.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a multi-channel switching-mode power supply (SMPS) including a first converter to rectify, switch, and transform AC power to generate a first DC power, a second converter to rectify, switch, and transform the AC power to generate a second DC power, a first power output unit to output the first DC power generated in the first converter, a second power output unit to output the second DC power generated in the second converter, and a second power feedback circuit unit to sense output of the first DC power from the first power output unit and immediately output a feedback signal which causes the second DC power to be generated, wherein the second converter generates the second DC power, and the second power output unit outputs the second DC power, in response to the feedback signal being output from the second power feedback circuit.

The foregoing and/or other features and utilities of the present general inventive concept may also be achieved by providing a multi-channel SMPS including a first converter to rectify, switch, and transform AC power to generate a first DC power, a plurality of second converters to rectify, switch, and transform the AC power to generate a plurality of second DC powers, a first power output unit to output the first DC power generated in the first converter, a plurality of second power output units which respectively correspond to the plurality of second converters and respectively output the plurality of second DC powers generated in the plurality of second converters and a plurality of power feedback circuit units to sense output of the first DC power from the first power output unit and immediately output a feedback signal which causes the second DC powers to be generated from the plurality of second converters, wherein the plurality of second converters respectively generate the second DC powers, and each of the plurality of second power output units outputs the respective second DC powers, in response to the feedback signal being output from the plurality of power feedback circuit units.

The foregoing and/or other features and utilities of the present general inventive concept may also be achieved by providing an image forming apparatus including a body of the image forming apparatus that forms an image by receiving power, and a multi-channel SMPS to supply power to the image forming apparatus, wherein the multi-channel SMPS includes a first converter to rectify, switch, and transform AC power to generate a first DC power, a second converter to rectify, switch, and transform the AC power to generate a second DC power, a first power output unit to output the first DC power generated in the first converter, a second power output unit to output the second DC power generated in the second converter, and a second power feedback circuit unit to sense output of the first DC power from the first power output unit and immediately output a feedback signal which causes the second DC power to be generated, wherein the second converter generates the second DC power, and the second power output unit outputs the second DC power, in response to the feedback signal being output from the second power feedback circuit.

The foregoing and/or other features and utilities of the present general inventive concept may also be achieved by providing an electronic device including a body of the electronic device that performs a predetermined function by receiving power, and a multi-channel SMPS to supply power to the body of the electronic device, wherein the multi-channel SMPS includes a first converter to rectify, switch, and transform AC power to generate a first DC power, a second converter to rectify, switch, and transform the AC power to generate a second DC power, a first power output unit to output the first DC power generated in the first converter, a second power output unit to output the second DC power generated in the second converter, and a second power feedback circuit unit to sense output of the first DC power from the first power output unit and immediately output a feedback signal which causes the second DC power to be generated, wherein the second converter generates the second DC power, and the second power output unit outputs the second DC power, in response to the feedback signal being output from the second power feedback circuit.

The foregoing and/or other features and utilities of the present general inventive concept may also be achieved by providing a multi-channel switching-mode power supply (SMPS) including a first power output unit to output a first power, and at least one feedback circuit to provide a feedback signal in response to the first power being output to notify at least one more component of the SMPS that the first power is being output.

The multi-channel SMPS may further include at least one second power output unit to output a second power in response to receiving the feedback signal.

The at least one feedback circuit may provide the feedback signal in response to receiving a light emitted from a light emitting device in the first power output unit.

The first power output unit may cause the light emitting device to stop emitting the light during a power save mode.

The foregoing and/or other features and utilities of the present general inventive concept may also be achieved by providing a multi-channel switching-mode power supply (SMPS) including a plurality of power output units corresponding to a plurality of channels of the SMPS, and at least one feedback circuit to detect power being output from any one of the power output units and send a signal causing power to be output from another of the power output units.

The foregoing and/or other features and utilities of the present general inventive concept may also be achieved by providing a multi-channel switching-mode power supply (SMPS) including a feedback circuit to detect a turn-on power being supplied to a first channel of the SMPS and to send a corresponding feedback signal to cause a driving power to be supplied to a second channel of the SMPS.

The multi-channel SMPS may further include a light emitting device corresponding to the first channel to emit light in response to the turn-on power being supplied, and a light receiving device corresponding to the feedback circuit to cause the feedback circuit to send the feedback signal in response to receiving the emitted light.

The light emitting device may stop emitting light in response to the SMPS receiving a power save mode signal.

The SMPS may be provided in an image forming apparatus, and the power save mode signal may be received from a controller provided in the image forming apparatus.

The foregoing and/or other features and utilities of the present general inventive concept may also be achieved by providing a method of supplying power from a multi-channel switching-mode power supply (SMPS), the method including detecting, with a feedback circuit, a turn-on power being supplied to a first channel of the SMPS, and sending a corresponding feedback signal to cause a driving power to be supplied to a second channel of the SMPS.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a block diagram illustrating a general configuration of a multi-channel switching-mode power supply (SMPS);

FIG. 2 is a block diagram illustrating a general configuration of a first converter or a second converter of the multi-channel SMPS illustrated in FIG. 1;

FIGS. 3A and 3B illustrate examples of configurations of a first power output unit and a second power feedback circuit unit of the multi-channel SMPS illustrated in FIG. 1;

FIG. 4 is a block diagram illustrating a configuration of a multi-channel SMPS according to another embodiment of the present general inventive concept;

FIGS. 5A and 5B illustrate configurations of a first power output unit and a second power feedback circuit unit of the multi-channel SMPS in FIG. 4, according to embodiments of the present general inventive concept;

FIG. 6 is a block diagram illustrating a configuration of a multi-channel SMPS according to another embodiment of the present general inventive concept; and

FIG. 7 is a block diagram illustrating an image forming device having a multi-channel SMPS according to an embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to the like elements throughout. The embodiments are described below in order to explain the present general inventive concept by referring to the figures.

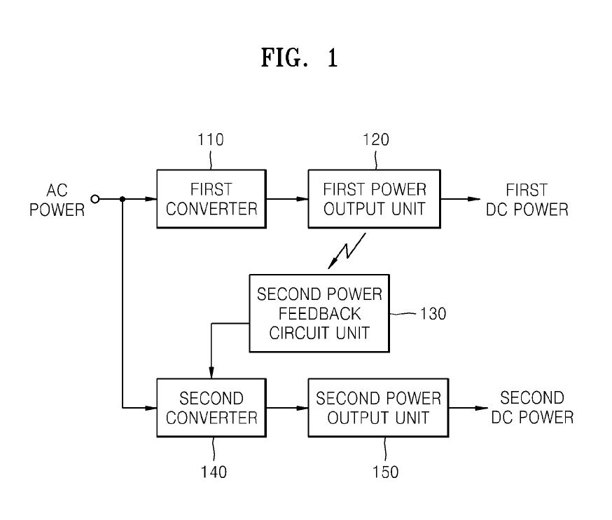

FIG. 1 is a block diagram illustrating a general configuration of a multi-channel switching-mode power supply (SMPS).

Referring to FIG. 1, the multi-channel SMPS may include a first converter 110, a second converter 140, a first power output unit 120, a second power output unit 150, and a second power feedback circuit unit 130.

The first converter 110 may rectify, switch, and transform an alternating current (AC) power supplied to the multi-channel SMPS to generate a first direct current (DC) power. The first power output unit 120 may output the first DC power generated in the first converter 110.

The second converter 140 may rectify, switch, and transform the AC power supplied to the multi-channel SMPS to generate a second DC power. The second power output unit 130 may output the second DC power generated in the second converter 140.

The second power feedback circuit unit 130 may receive a predetermined signal from the first power output unit 120 and output a feedback signal to the second converter 140. The feedback signal may allow the second DC power to be generated and output.

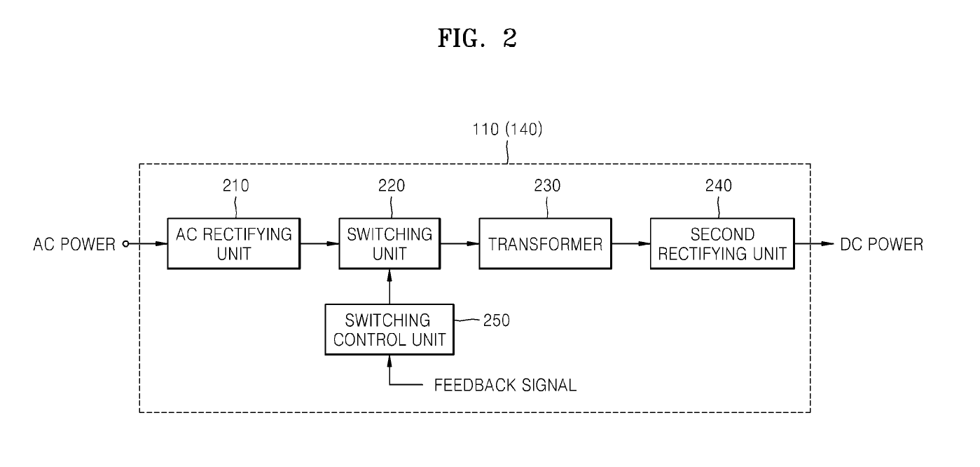

FIG. 2 is a block diagram illustrating a general configuration of the first converter 110 or the second converter 140 of the multi-channel SMPS illustrated in FIG. 1. Although the general configuration illustrated in FIG. 2 may be incorporated in the first converter 110 and/or the second converter 140, the configuration will be described herein with respect to the first converter 110 for convenience. However, the components illustrated therein may be referred to in the following descriptions in regard to either the first converter 110 or the second converter 140.

Referring to FIG. 2, the first converter 110 may include an AC rectifying unit 210, a switching unit 220, a transformer 230, a second rectifying unit 240, and a switching control unit 250.

The AC rectifying unit 210 may receive and rectify the AC power supplied to the multi-channel SMPS. The switching unit 220 may switch according to a switching control signal received from the switching control unit 250, and may convert a voltage that is output from the AC rectifying unit 210 into a square AC. When power is supplied to a primary side of the transformer 230, power which is proportional to a turn ratio between the primary side of the transformer 230 and a secondary side of the transformer 230 may be produced through induction and output from the secondary side of the transformer 230. The second rectifying unit 240 may rectify the power output from the secondary side of the transformer 230. The switching control unit 250 may control switching of the switching unit 220 according to the feedback signal to be input thereto.

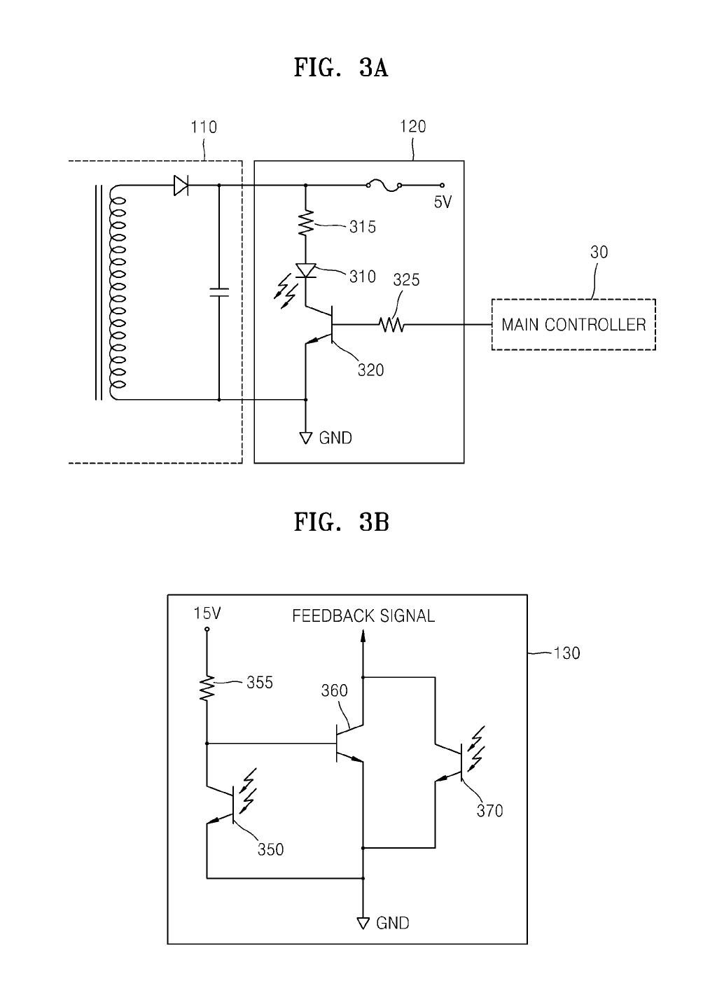

FIGS. 3A and 3B are examples illustrating configurations of the first power output unit 120 and the second power feedback circuit unit 130 of the multi-channel SMPS illustrated in FIG. 1.

In a multi-channel SMPS using multiple output channels, in order to minimize power consumption in a power save mode a minimum power to operate a main controller 30 of an image forming apparatus to which power is supplied may be maintained in one channel in the power save mode, and the other power channels may be turned-off.

In FIG. 3A, a 5V channel may be used as power of the main controller 30 of the image forming apparatus, and a 24V channel may be turned-off in the power save mode. The 5V and 24V channels described herein are merely exemplary, and other channels having various values may be used.

The first power output unit 120 and the second power feedback circuit unit 130 which are illustrated in FIGS. 3A and 3B will be described initially in a case in which the power to the image forming apparatus is turned on. In the following descriptions, power supplied through a 5V channel is referred to as 5V power, power supplied through a 24V channel is referred to as 24V power, and so on.

In response to turning a power switch of the SMPS on, 5V power may be input to the image forming apparatus and initialization of the main controller 30 may be completed. In response to being initialized, the main controller 30 may apply a signal to turn on a first transistor 320. A resistor 325 may be provided as a protective resistor of the first transistor 320. When the signal from the main controller 30 is applied to the first transistor 320, the first transistor 320 may be turned-on.

In response to the first transistor 320 being turned-on, a photocoupler light emitting device 310 may start emitting light. A resistor 315 may be provided as a protective resistor of the photocoupler light emitting device 310.

In response to the photocoupler light emitting device 310 emitting light, a photocoupler light receiving device 350 of the second power feedback circuit unit 130 may receive the light emitted from the photocoupler light emitting device 310. In the state in which the photocoupler light receiving device 350 is receiving the light emitted from the photocoupler light emitting device 310, the photocoupler light receiving device 350 may be short-circuited, and a second transistor 360 may be turned off due to the resulting short circuit created by the photocoupler light receiving device 250 being turned on. In the state in which the second transistor 360 may be turned off, a feedback signal may be input to the switching control unit 250 of the second converter 140 so that the second converter 140 generates 24V power, and thus 24V power may be output from the SMPS through the second power output unit 150. The level of the feedback signal may become high by using a voltage maintained by a second power photocoupler light receiving unit 370.

Next, a power save mode will be described. The main controller 30 of the image forming apparatus may apply a power save signal to the first power output unit 120. More particularly, the main controller 30 may apply a signal to turn the first transistor 320 off. In response to the first transistor 320 being turned off, the photocoupler light emitting device 310 may stop emitting light. In a state in which the photocoupler light emitting device 310 does not emit light, the photocoupler light receiving device 350 may not receive light from the photocoupler light emitting device 310. In response to the photocoupler light receiving device 350 not receiving the light emitted from the photocoupler light emitting device 310, the photocoupler light receiving device 350 may be opened (due to being turned off), and thus the second transistor 360 may be turned on. Thus, the feedback signal which was previously fed back to the switching control unit 250 of the second converter 140 may be short-circuited to a reference potential such as ground, and thus the second converter 140 may not generate 24V power.

As described above, when the power switch of the SMPS is turned on, 5V power may be output to the image forming apparatus. Then, a signal used to turn 24V power on may be input from the main controller 30 of the image forming apparatus. When the power switch of the SMPS is turned off again before the 24V power is turned on or when a power cord is unplugged, since the load of the image forming apparatus due to the 5V power is small, energy stored in the SMPS cannot be sufficiently discharged and remains in the SMPS. At this time, if a user touches the unplugged power cord, the user might get an electric shock due to the remaining energy.

When power supply is stopped, energy charged in a capacitor may be discharged due to two factors. First, the energy charged in the capacitor may be discharged by a discharge circuit of the capacitor. When the capacitor and a resistor are connected to each other in parallel, this configuration may function as a discharge circuit. A capacitor's charge in the discharge circuit may be obtained by Equation 1 below:

$${q}^{′} = {q}_{0} {e}^{\frac{t}{RC}} \qquad [ Equation 1 ]$$

wherein, RC(=T) is a time constant. Since a capacitance C of the capacitor is a fixed value, as a resistance R decreases, a discharge speed of the capacitor increases. In other words, the smaller the value of the resistance R, the faster the discharge speed of the capacitor when power is turned off. Thus, the remaining energy may be small and the risk of an electric shock may be decreased. However, when the value of the resistance R is small, power consumption increases, thereby causing an adverse effect on low power consumption. Accordingly, the resistance R may be fixed and used so that the time constant of the resistance R is not decreased below a standard value. Thus, decreasing the resistance R is not desirable.

Second, a discharge speed of energy charged by the amount of load in a secondary side of the transformer may be changed. The SMPS may control the amount of energy sent to the load of the secondary side of the transformer by switching according to the amount of load in the secondary side through a feedback circuit. That is, as the amount of load in the secondary side is large, the energy charged in the capacitor may be quickly consumed. Accordingly, when the power switch of the SMPS is turned-off, the time spent discharging the capacitor is determined depending on the amount of load in the secondary side. For example, in the case of a capacitor having a capacitance of about 300 uF, the time spent discharging the capacitor with respect to the 0.3 W load takes about 30 seconds when the discharge resistance is not provided.

Since a low voltage is applied to a 5V load terminal, a variation in capacitance of the capacitor with respect to a variation in load current is relatively small. Conversely, since a high voltage is applied to a 24V load terminal, even though the load current may only slightly increase, a variation in capacitance of the capacitor may be large. For example, when the load current is increased by 0.1 A, the capacitance may be increased by 2.4 W (=24V*0.1 A), which indicates that a discharge time of the capacitor can be shortened. As such, discharging the capacitor by using a load receiving 24V power may prevent the risk of an electric shock.

When the initialization of the main controller of the image forming apparatus is finished by receiving 5V power, 24V power may be turned on. In this case, the time before entering a product using state may be delayed.

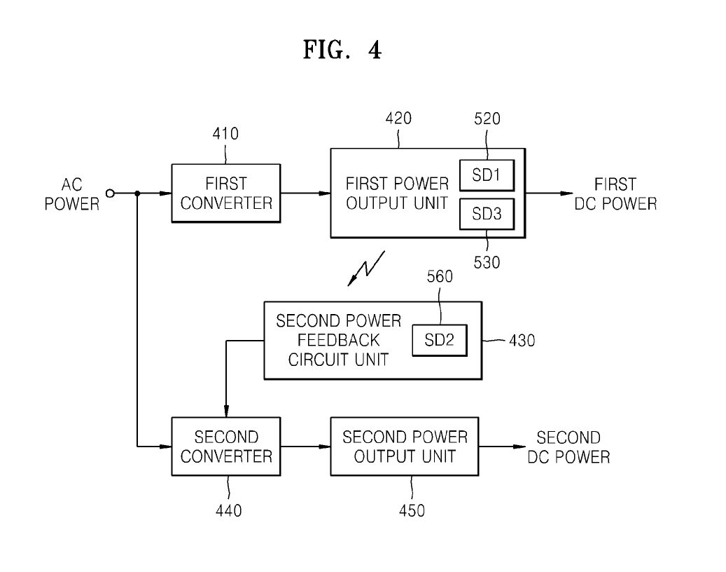

FIG. 4 is a block diagram illustrating a configuration of a multi-channel SMPS according to another embodiment of the present general inventive concept.

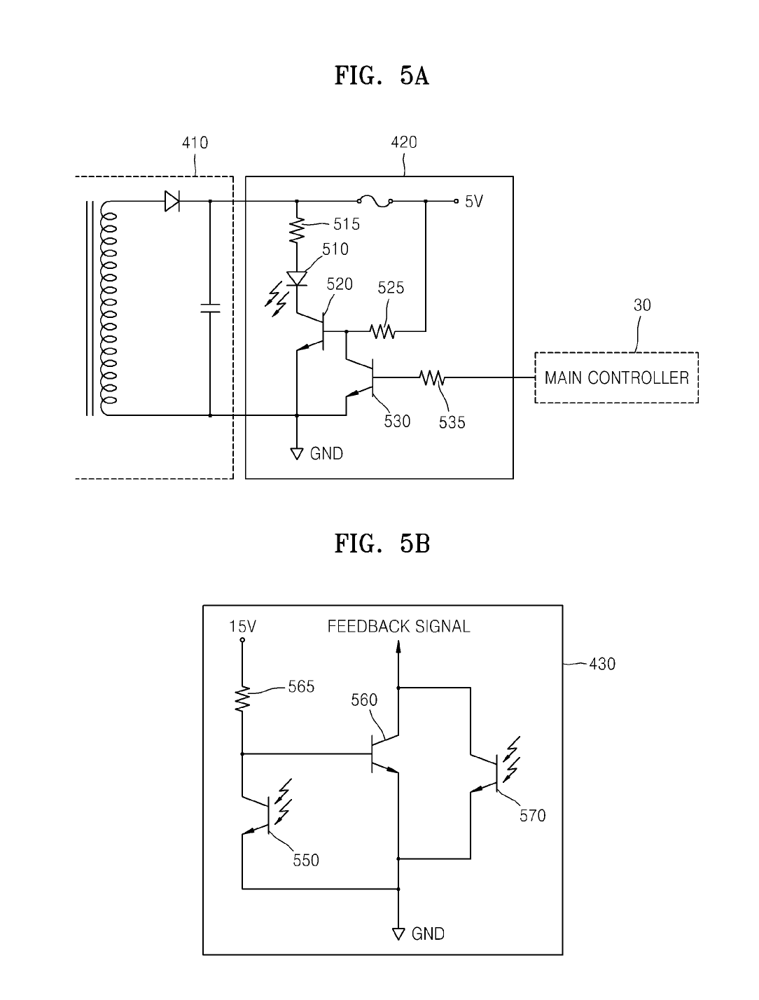

Referring to FIG. 4, the multi-channel SMPS may include a first converter 410, a second converter 440, a first power output unit 420, a second power output unit 450, and a second power feedback circuit unit 430. Additionally, the multi-channel SMPS of FIG. 4 may include a first switching device 520, a second switching device 560, and a third switching device 530. The first through third switching devices 520, 560, and 530 will be discussed in more detail in regard to FIGS. 5A and 5B.

FIGS. 5A and 5B illustrate configurations of the first power output unit 420 and the second power feedback circuit unit 430 according to an embodiment of the present general inventive concept.

The first converter 410 may rectify, switch, and transform an AC power supplied to the multi-channel SMPS to generate a first DC power. The second converter 440 may rectify, switch, and transform the AC power to generate a second DC power. Each of the first converter 410 and the second converter 440 may include the AC rectifying unit 210, the switching unit 220, the transformer 230, the second rectifying unit 240, and the switching control unit 250, as illustrated in FIG. 2.

The first DC power and second DC power may represent two channels through which different levels of power are supplied to an electronic device. For example, the first DC power may be the power supplied to a main controller of the electronic device, and the second DC power may be the power supplied to the electronic device during an operation mode of the electronic device. Therefore, the first DC power may be supplied through a channel with a lower voltage than that of the channel supplying the second DC power. Such a configuration may use a 5V channel to supply the first DC power, and a 24V channel to supply the second DC power. However, the present general inventive concept is not limited to these voltage levels.

The first power output unit 420 may output the first DC power generated in the first converter 410. The second power output unit 450 may output the second DC power generated in the second converter 440.

The second power feedback circuit unit 430 may sense that the first DC power is output from the first power output unit 420, and may immediately output a feedback signal to allow the second DC power to be generated from the second converter 440.

The first power output unit 420 may include a photocoupler light emitting unit 510 and the first switching device 520, and may further include the third switching device 530.

When the first DC power is output from the first power output unit 420, the photocoupler light emitting unit 510 may emit light due to the first DC power. One terminal of the first switching device 520 may be connected to the photocoupler light emitting unit 510. The first switching device 520 may include a control terminal to control an ON/OFF state of the first switching device 520, and a transistor may be used as the first switching device 520 (hereinafter, referred to as ‘first transistor’).

The first power output unit 420 may include a photocoupler load resistor 515 connected between one terminal of the photocoupler light emitting unit 510 and the first DC power, and a first transistor protective resistor 525 connected between the first DC power and a base terminal of the first transistor 520.

When the first DC power is output, the base terminal of the first transistor 520, which is a control terminal of the first transistor 520, may respond to the first DC power by turning on the first transistor 520. When the first transistor 520 is turned-on, the photocoupler light emitting unit 510 may emit light.

The second power feedback circuit unit 430 may include a photocoupler light receiving unit 550 and the second switching device 560. The photocoupler light receiving unit 550 may receive light emitted from the photocoupler light emitting unit 510 of the first power output unit 420.

A control terminal to control ON/OFF switching of the second switching device 560 may be connected to one terminal of the photocoupler light receiving unit 550, and one terminal of the second switching device 560 may be supplied with a feedback signal. A transistor may be used as the second switching device 560 (hereinafter, referred to as a second transistor).

The second power feedback circuit unit 430 may include a protective resistor 565 provided to the second transistor 560. The second transistor protective resistor 565 may be connected between a power terminal used to supply power to the photocoupler light receiving unit 550 and one terminal of the photocoupler light receiving unit 550, and one terminal of the second transistor 560 may be connected to the one terminal of the photocoupler light receiving unit 550.

When the photocoupler light receiving unit 550 receives light from the first photocoupler light emitting unit 510 of the first power output unit 420, the second power feedback circuit unit 430 may output a feedback signal to allow the second DC power to be generated from the second converter 440. More particularly, when the photocoupler light receiving unit 550 receives light emitted from the photocoupler light emitting unit 510 of the first power output unit 420, the photocoupler light receiving unit 550 may be short-circuited to a reference potential, and thus the second transistor 560 may be turned-off by due to not receiving a signal at the base terminal, which is a control terminal of the second transistor 560. When the second transistor 560 is turned-off, a level of the feedback signal used to control the second DC power to be generated from the second converter 440 may become high and be output. The second converter 440 may generate the second DC power according to the feedback signal. In the current embodiment of the present general inventive concept, the level of the feedback signal may become high by using a voltage maintained by a second power photocoupler light receiving unit 570, but a high-level signal may be applied forcefully from the outside without using the second power photocoupler light receiving unit 570.

The reference potential to which the feedback signal may be short-circuited may be, for example, a ground potential. However, although this reference potential is illustrated in FIGS. 5A-B as the ground potential, the present general inventive concept is not limited thereto.

In order to minimize power consumption in a power save mode, the first power output unit 420 may receive a power save signal from a main controller 50, and thus the photocoupler light emitting unit 510 may stop emitting light. To perform this operation, the first power output unit 420 may further include the third switching device 530, and a transistor may be used as the third switching device 530 (hereinafter, referred to as a third transistor). The first power output unit 420 may further include a third transistor protective resistor 535 connected between an input terminal of the main controller 50 and the third transistor 530.

When the power save signal is input to the third transistor 530 from the main controller 50, the first transistor 520 may be turned-off, and thus the photocoupler light emitting unit 510 may stop emitting light.

More particularly, when the main controller 50 sends the power save signal to the gate of the third transistor 530, the third transistor 530 may be turned on. Upon the third transistor 530 being turned on, the signal which was previously going to the gate of the first transistor 520 is diverted through the third transistor 530 to the reference potential. As the signal may no longer reach the gate of the first transistor 520 to turn the first transistor 520 on, the photocoupler light emitting unit 510 may stop emitting light.

If the photocoupler light receiving unit 550 of the second power feedback circuit unit 430 does not receive light emitted from the photocoupler light emitting unit 510 of the first power output unit 420, the photocoupler light receiving unit 550 is opened. When the photocoupler light receiving unit 550 is opened, the second transistor 560 is turned-on by the base terminal of the second transistor 560. Thus, the feedback signal connected to one terminal of the second transistor 560 may be connected to the reference potential and may become 0V. Accordingly, as the feedback signal becomes 0V, the second converter 440 may not generate the second DC power.

Since the present general inventive concept relates to a multi-channel SMPS, more than two power sources may be output by receiving AC power. In the aforementioned embodiment, 5V DC power is used as the first DC power, and 24V DC power is used as the second DC power, but the present general inventive concept is not limited thereto. The output power may also use a third power, fourth power, or the like.

Accordingly, the current embodiment of the present general inventive concept may include a plurality of converters instead of only the illustrated second converter, and may include a plurality of power output units and a plurality of power feedback circuit units which correspond to the plurality of converters.

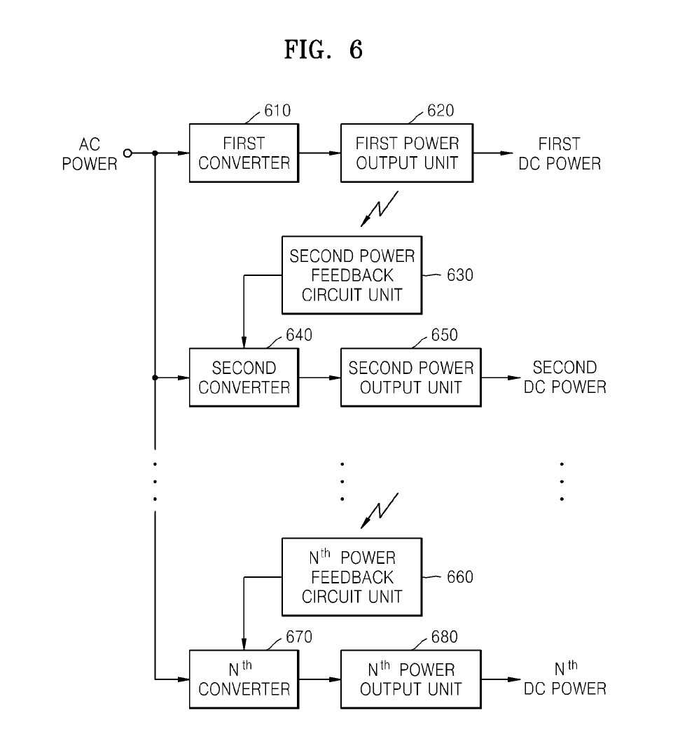

FIG. 6. is a block diagram illustrating a configuration of a multi-channel SMPS according to another embodiment of the present general inventive concept. In the embodiment illustrated in FIG. 6, the multi-channel SMPL may include N converters 610, 640, . . . 670 and power output units 620, 650, . . . 680 and therefore N power channels, and may include N-1 power feedback circuit units 630, . . . 660 to supply feedback signals to the second through N converters 640, . . . 670 according to the first power output unit 620. However, the present general inventive concept is not limited to this configuration. For example, the plurality of second through N converters 640, . . . 670 may all receive feedback signals from a common feedback circuit unit.

Each of the converters 610, . . . 670 may include components such as those illustrated in FIG. 2, and each of the converters 610, . . . 670 may rectify, switch, and transform AC power to generate DC power. The plurality of power output units 620, . . . 680 may respectively correspond to the plurality of converters 610, . . . 670 and may respectively output the plurality of power generated in the plurality of converters 610, . . . 670. The plurality of power feedback circuit units 630, . . . 660 may sense an output of the first DC power from the first power output unit 620 and immediately output a feedback signal to allow power to be generated from the plurality of converters 640, . . . 670.

As described above, in the current embodiment of the present general inventive concept, 5V power, which is the first DC power, may be turned on, and the same time the 24V power, which is the second DC power, may be turned on in response to the 5V power being turned on, so that the time used in entering an initial power save mode of the electronic product can be shortened. In a conventional configuration, the 5V power is turned-on and then is applied to a main controller, and initialization of the main controller is finished. Then, because the main controller outputs a 24V driving signal to perform 24V driving only after the initialization of the main controller, the time taken to perform the initialization is required to be spent before performing the 24V driving. On the other hand, in the current embodiment of the present general inventive concept, when the 5V power is turned-on, the 24V power is immediately turned-on, and thus the time used to initialize the main controller before performing the 24V driving is not necessary, and thereby the time needed to enter an initial power save mode of the electronic product may be shortened.

Even though a power switch may be turned on and then immediately turned off, since loads of the 5V power and the 24V power exist together, the stored capacitance energy is discharged at a high speed, thereby preventing the risk of an electric shock. Also, when a product enters a power save mode, the 24V power can be turned off.

In a multi-channel SMPS, all of the channels except for a channel used to drive a main controller at minimum power consumption in a power save mode should be turned-off. However, in such an process, a time difference between operation timings of each channel may occur, thereby presenting a safety hazard.

According to the current embodiment of the present general inventive concept, only one transistor TR and a few resistors may be added, and changing a configuration of a circuit thusly can eliminate a safety hazard and lower the power consumption. The present general inventive concept provides a method of eliminating a safety hazard and lowering the power consumption, and the method may be used in a multi-channel SMPS.

The present general inventive concept provides an image forming apparatus including a multi-channel SMPS which allows a higher voltage channel to receive power in response to a lower voltage channel receiving power.

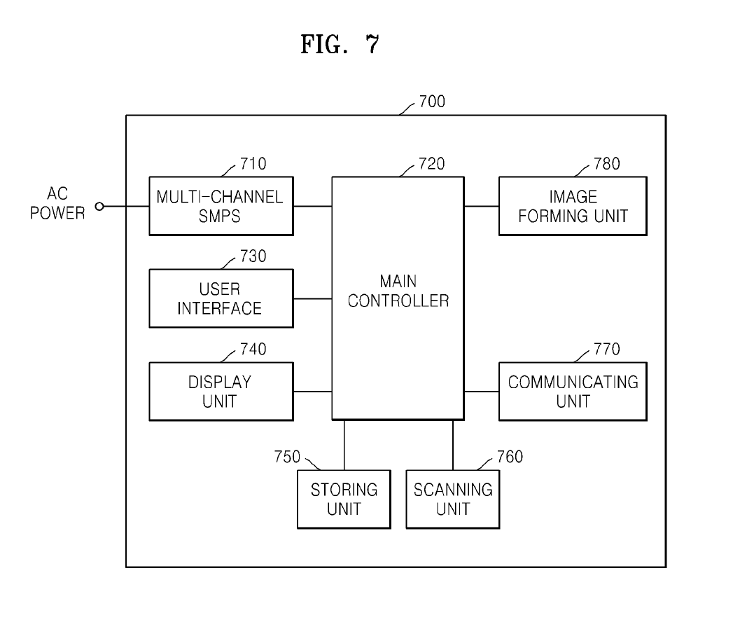

FIG. 7 is a block diagram illustrating an image forming device having a multi-channel SMPS according to an embodiment of the present general inventive concept. The image forming apparatus 700 includes a body to form an image by receiving AC power which is received by a multi-channel SMPS 710 which then supplies power to the image forming apparatus 700 according to control of the main controller 720. The image forming apparatus 700 may include a user interface 730 through which a user may enter data, instructions, passwords, etc., which may then be sent to the main controller 720, a display unit 740 through which the main controller 720 may cause various images, notifications, password requests, etc., to be displayed to the user, a storing unit 750 in which to store data such as print data, programs, approved users, etc., a scanning unit 760 which may be used to scan documents so as to convert a document image to print data, a communicating unit 770 which may be used to transmit and/or receive print data, user data, etc., to other devices, and an image forming unit 780 to form an image onto a print medium using print data. DC power may be supplied directly to one or more of these parts of the image forming apparatus 700 through one or more of the power output units illustrated in FIG. 6.

The multi-channel SMPS 710 may be the same as the multi-channel SMPS described with reference to FIGS. 4, 5A and 5B. The image forming apparatus 700 may also include the aforementioned multi-channel SMPS 710 with more than two output channels.

The multi-channel SMPS according to the present general inventive concept can be applied not only to an image forming apparatus, but also to other electronic devices, such as a mobile communication device, a display device (for example, a liquid crystal display (LCD), a plasma display panel (PDP)), a television, a refrigerator, a washing machine, etc.

Accordingly, the present general inventive concept may include an electronic device including the multi-channel SMPS according to the present general inventive concept. That is, the electronic device may include a body to perform a predetermined function by receiving power and a multi-channel SMPS to supply power to the body. The multi-channel SMPS may be the same as the multi-channel SMPS described with reference to FIGS. 4, 5A and 5B. The electronic device may also include the aforementioned multi-channel SMPS having more than two output channels.

Although various example embodiments of the present general inventive concept have been illustrated and described, it will be appreciated by those skilled in the art that changes may be made in these example embodiments without departing from the principles and spirit of the present general inventive, the scope of which is defined in the appended claims and their equivalents.

What is claimed is:

1. A multi-channel switching-mode power supply (SMPS) comprising:
a first converter to rectify, switch, and transform alternating current (AC) power to generate a first direct current (DC) power;
a second converter to rectify, switch, and transform the AC power to generate a second DC power;
a first power output unit to output the first DC power generated in the first converter;
a second power output unit to output the second DC power generated in the second converter; and
a second power feedback circuit unit to sense output of the first DC power from the first power output unit and immediately output a feedback signal which causes the second DC power to be generated;
wherein the second converter generates the second DC power, and the second power output unit outputs the second DC power, in response to the feedback signal being output from the second power feedback circuit unit.

2. The multi-channel SMPS of claim 1, wherein the first power output unit comprises a photocoupler light emitting unit which emits light due to the first DC power being output; and
the second power feedback circuit unit comprises a photocoupler light receiving unit to receive the light emitted from the photocoupler light emitting unit of the first power output unit and outputs a feedback signal causing the second DC power to be generated from the second converter in response to receiving the emitted light.

3. The multi-channel SMPS of claim 1, wherein the first power output unit comprises:
a photocoupler light emitting unit to emit light, and
a first switching device including one terminal connected to the photocoupler light emitting unit and a control terminal to control ON/OFF switching of the first switching device,
wherein the control terminal turns the first switching device on in response to the first DC power being output, and the photocoupler light emitting unit emits light in response to the first switching device being turned on; and
the second power feedback circuit unit comprises:
a photocoupler light receiving unit to receive the light output from the photocoupler light emitting unit, and
a second switching device including one terminal supplied with the feedback signal and a control terminal to control ON/OFF switching of the second switching device,
wherein the control terminal is connected to one terminal of the photocoupler light receiving unit;
wherein the second switching device is turned off by the control terminal of the second switching device in response to the photocoupler light receiving unit receiving light, and the second power feedback circuit outputs the feedback signal to cause the second DC power to be generated from the second converter unit in response to the second switching device being turned off.

4. The multi-channel SMPS of claim 3, wherein the first switching device is a first transistor, and the second switching device is a second transistor.

5. The multi-channel SMPS of claim 4, wherein the first power output unit comprises:
a photocoupler load resistor connected between one terminal of the photocoupler light emitting unit and the first DC power; and
a first transistor protective resistor connected between an input terminal of the power save signal and the first transistor; and
the second power feedback circuit unit comprises:
a second transistor protective resistor connected between a power terminal supplying power to the photocoupler light receiving unit and one terminal of the photocoupler light receiving unit, and also connected to one terminal of the second transistor.

6. The multi-channel SMPS of claim 2, wherein the photocoupler light emitting unit stops emitting light in response to receiving a power save signal; and
the second power feedback circuit unit causes the second DC power not to be generated from the second converter by not outputting the feedback signal in response to the photocoupler light receiving unit not receiving light from the photocoupler light emitting unit.

7. The multi-channel SMPS of claim 3, wherein the first power output unit further comprises:
a third switching device to turn off the first switching device so that the photocoupler light emitting unit does not emit light in response to a power save signal being received;
wherein the photocoupler light receiving unit is short-circuited in response to the photocoupler light receiving unit of the second power feedback circuit receiving the light from the photocoupler light emitting unit, and the photocoupler light receiving unit is open-circuited in response to the photocoupler light receiving unit not receiving the light from the photocoupler light emitting unit; and
the second switching device of the second power feedback circuit unit is turned on in response to the photocoupler light receiving unit being open-circuited, so that the second DC power is not generated from the second converter due to the feedback signal not being supplied from the second power feedback circuit.

8. The multi-channel SMPS of claim 7, wherein the first switching device is a first transistor, the second switching device is a second transistor, and the third switching device is a third transistor.

9. The multi-channel SMPS of claim 8, wherein the first power output unit comprises a third transistor protective resistor connected between an input terminal of the power save signal and the third transistor, and
the first transistor protective resistor is connected between the first dc power and the first transistor.

10. A multi-channel switching-mode power supply (SMPS) comprising:
a first converter to rectify, switch, and transform alternating current (AC) power to generate a first direct current (DC) power;
a plurality of second converters to rectify, switch, and transform the AC power to generate a plurality of second DC powers;
a first power output unit to output the first DC power generated in the first converter;
a plurality of second power output units which respectively correspond to the plurality of second converters and respectively output the plurality of second DC powers generated in the plurality of second converters; and
a plurality of power feedback circuit units to sense output of the first DC power from the first power output unit and immediately output a feedback signal which causes the second DC powers to be generated from the plurality of second converters,
wherein the plurality of second converters respectively generate the second DC powers, and each of the plurality of second power output units outputs the respective second DC powers, in response to the feedback signal being output from the plurality of power feedback circuit units.

11. The multi-channel SMPS of claim 10, wherein the first power output unit comprises a photocoupler light emitting unit which emits light due to the first DC power being output; and
each of the power feedback circuit units comprises a photocoupler light receiving unit to receive the light from the photocoupler light emitting unit of the first power output unit and outputs a feedback signal to cause the second DC powers to be generated from the corresponding second converters.

12. The multi-channel SMPS of claim 11, wherein the first power output unit stops the photocoupler light emitting unit from emitting light in response to a power save signal being input; and
each of the power feedback circuit units causes the second DC powers to not be generated from the second converters by not outputting the feedback signal in response to the respective photocoupler light receiving units not receiving light from the photocoupler light emitting unit.

13. An image forming apparatus comprising:
a body of the image forming apparatus that forms an image by receiving power; and
a multi-channel switching-mode power supply (SMPS) to supply power to the image forming apparatus;
wherein the multi-channel SMPS comprises:
a first converter to rectify, switch, and transform alternating current (AC) power to generate a first direct current (DC) power;
a second converter to rectify, switch, and transform the AC power to generate a second DC power;
a first power output unit to output the first DC power generated in the first converter;
a second power output unit to output the second DC power generated in the second converter; and
a second power feedback circuit unit to sense output of the first DC power from the first power output unit and immediately output a feedback signal which causes the second DC power to be generated;
wherein the second converter generates the second DC power, and the second power output unit outputs the second DC power, in response to the feedback signal being output from the second power feedback circuit unit.

14. The image forming apparatus of claim 13, wherein the first power output unit comprises a photocoupler light emitting unit which emits light due to the first DC power being output; and
the second power feedback circuit unit comprises a photocoupler light receiving unit to receive the light emitted from the photocoupler light emitting unit of the first power output unit and outputs a feedback signal causing the second DC power to be generated from the second converter in response to receiving the emitted light.

15. The image forming apparatus of claim 14, wherein the photocoupler light emitting unit stops emitting light in response to receiving a power save signal; and
the second power feedback circuit unit causes the second DC power not to be generated from the second converter by not outputting the feedback signal in response to the photocoupler light receiving unit not receiving light from the photocoupler light emitting unit.

16. An electronic device comprising:
a body of the electronic device that performs a predetermined function by receiving power; and
a multi-channel switching-mode power supply (SMPS) to supply power to the body of the electronic device,
wherein the multi-channel SMPS comprises:
a first converter to rectify, switch, and transform alternating current (AC) power to generate a first direct current (DC) power;
a second converter to rectify, switch, and transform the AC power to generate a second DC power;
a first power output unit to output the first DC power generated in the first converter;
a second power output unit to output the second DC power generated in the second converter; and
a second power feedback circuit unit to sense output of the first DC power from the first power output unit, and immediately output a feedback signal to cause the second DC power to be generated;
wherein the second converter generates the second DC power, and the second power output unit outputs the second DC power, in response to the feedback signal being output from the second power feedback circuit unit.

17. The electronic device of claim 16, wherein the first power output unit comprises a photocoupler light emitting unit which emits light due to the first DC power being output; and
the second power feedback circuit unit comprises a photocoupler light receiving unit to receive the light emitted from the photocoupler light emitting unit of the first power output unit and outputs a feedback signal causing the second DC power to be generated from the second converter in response to receiving the emitted light.

18. The electronic device of claim 17, wherein the photocoupler light emitting unit stops emitting light in response to receiving a power save signal; and
the second power feedback circuit unit causes the second DC power not to be generated from the second converter by not outputting the feedback signal in response to the photocoupler light receiving unit not receiving light from the photocoupler light emitting unit.

19. A multi-channel switching-mode power supply (SMPS) comprising:
a first power output unit to output a first power;
at least one feedback circuit to provide a feedback signal in response to the first power being output to notify at least one more component of the SMPS that the first power is being output; and
at least one second power output unit to output a second power in response to receiving the feedback signal.

20. The multi-channel SMPS of claim 19, wherein the at least one feedback circuit provides the feedback signal in response to receiving a light emitted from a light emitting device in the first power output unit.

21. The multi-channel SMPS of claim 20, wherein the first power output unit causes the light emitting device to stop emitting the light during a power save mode.

22. A method of supplying power from a multi-channel switching-mode power supply (SMPS), the method comprising:
detecting, with a feedback circuit, a turn-on power being supplied to a first channel of the SMPS; and
sending a corresponding feedback signal to cause a driving power to be supplied to a second channel of the SMPS.
